(19) United States
(12) Patent Application Publication
(10) Pub. No.: US 2014/0355013 A1
(43) Pub. Date: Dec. 4, 2014

(54) Systems and Methods for Red-Eye Correction

(71) Applicant: Marvell World Trade Ltd., St. Michael (BB)

(72) Inventors: Pamela Voss, Corvallis, OR (US); Jay McDougal, Corvallis, OR (US)

(73) Assignee: Marvell World Trade Ltd., St. Michael (BB)

(21) Appl. No.: 14/282,046

(22) Filed: May 20, 2014

Related U.S. Application Data
(60) Provisional application No. 61/828,127, filed on May 28, 2013.

(51) Int. Cl. G06T 5/00; G06K 15/02; H04N 9/73

(52) U.S. Cl. CPC G06T 5/001; H04N 9/735; G06K 15/1872
USPC 358/1.9; 382/163; 348/241

(57) ABSTRACT

Systems and methods are provided for correcting red-eye in a digital image. an identification of pixels in a color image where red-eye is to be corrected is accessed. At least a portion of the color image is converted from a color representation to generate a grayscale representation. The color image is adjusted by replacing identified pixels in the color image with corresponding pixels from the grayscale representation to generate an adjusted color image, and the adjusted color image is saved in a computer-readable medium.

### CROSS-REFERENCE TO RELATED APPLICATIONS

The present application claims priority from U.S. Provisional Application Ser. No. 61/828,127 entitled “Red-Eye Correction Algorithm,” filed 28 May 2013, the entirety of which is hereby incorporated by reference.

### FIELD

This disclosure is related generally to image processing and more particularly to digital image red-eye reduction.

### BACKGROUND

Red-eye is an undesirable phenomenon occurring when light from a camera flash is reflected off of blood vessels at the back of an eye and is captured by a camera lens. Red-eye is common in camera applications, such as point-and-shoot cameras, where the flash is positioned close to the camera lens. The light from the flash, reflected off of the blood vessels, creates red portions at the pupil of eyes that appear in the picture, leaving an undesirable effect.

### SUMMARY

Systems and methods are provided for correcting red-eye in a digital image. An identification of pixels in a color image where red-eye is to be corrected is accessed. At least a portion of the color image is converted from a color representation to generate a grayscale representation. The color image is adjusted by replacing identified pixels in the color image with corresponding pixels from the grayscale representation to generate an adjusted color image, and the adjusted color image is saved in a computer-readable medium.

As another example, a system for correcting red-eye in a digital image includes one or more computer-readable mediums configured to store a color image and an identification of pixels in the color image where red-eye is to be corrected. A grayscale conversion module is configured to convert at least a portion of the color image from a color representation to generate a grayscale representation. A color adjustment module is configured to adjust the color image by replacing identified pixels in the color image with corresponding pixels from the grayscale representation to generate an adjusted color image, where the adjusted color image is stored in the one or more computer-readable mediums.

### BRIEF DESCRIPTION OF THE DRAWINGS

FIG. 1 is a block diagram depicting a processor-implemented system for correcting red-eye.

FIG. 2A depicts a color image that is to have red-eye correction performed on it.

FIG. 2B depicts a pixel mask that includes a value for each of a plurality of pixels of the color image.

FIG. 3 is a conceptual flog r diagram depicting a method of correcting red-eye in a digital image.

FIG. 4 is a block diagram depicting a system for correcting red-eye in a digital image that includes red-eye detection.

FIG. 5 is a block diagram depicting a system for correcting red-eye in a digital image that includes grayscale representation processing.

FIG. 6 is a block diagram depicting a system for correcting red-eye in a digital camera.

FIG. 7 is a block diagram depicting a printer configured to correct red-eye in a digital image.

FIG. 8 is a flow diagram depicting a processor-implemented method of correcting red-eye in a digital image.

### DETAILED DESCRIPTION

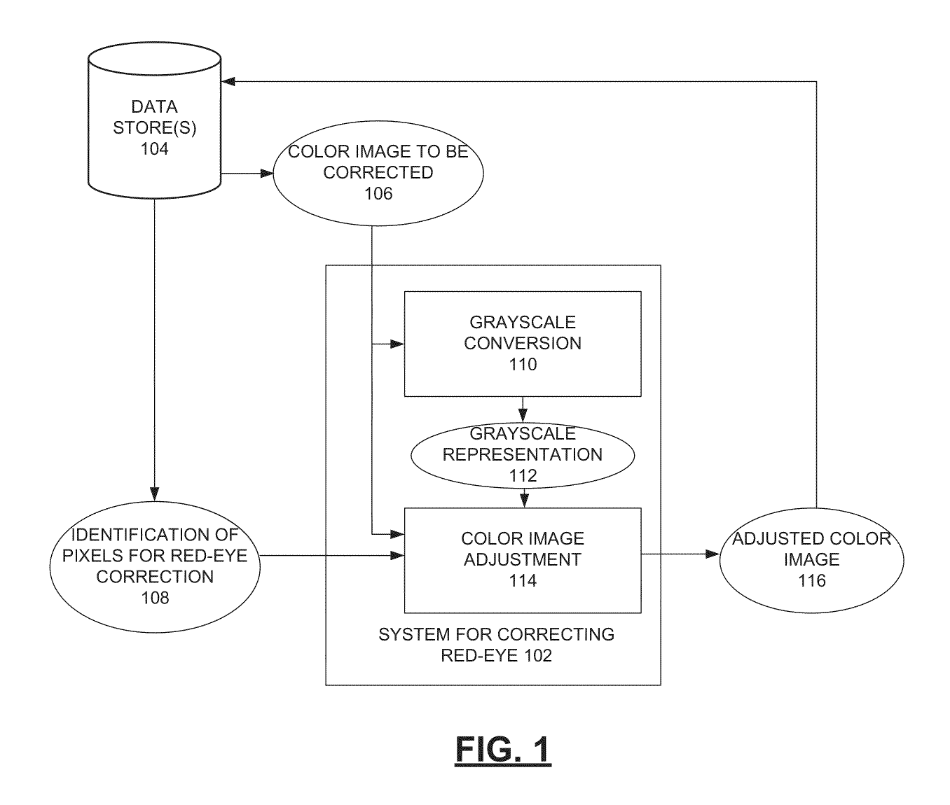

FIG. 1 is a block diagram depicting a processor-implemented system for correcting red-eye. A system for correcting red-eye 102 is responsive to one or more data stores 104 which may be integrated with or external to the system for correcting red-eye 102. The data store contains a color image to be corrected 106 as well as an identification 108 of pixels in the color image 106 where red-eye is to be corrected. At 110, the system for correcting red-eye 102 performs a grayscale conversion on at least a portion of the color image to generate a grayscale representation 112 (e.g., an RGB representation where the Red Value=Green Value=Blue value for each pixel). In one example, the grayscale conversion 110 converts portions of the color image 106 corresponding to identified pixels 108 to be adjusted to grayscale in generating the grayscale representation 112. Color image adjustment is performed at 114, where the color image 106 is adjusted by replacing identified pixels 108 in the color image 106 with corresponding pixels from the grayscale representation 1112 to generate an adjusted color image 116, where the adjusted color image is saved in a computer-readable medium such as the data store 104.

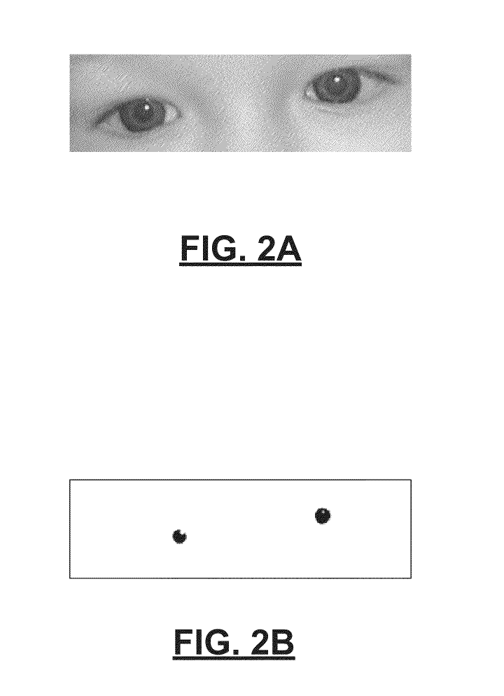

FIG. 2A depicts a color image that is to have red-eye correction performed on it. Pixels within the color image where red-eye is to be corrected are identified, such as via well known red-eye detection operations. In one example, pixels within a threshold-range of the color red in the color image are identified as candidates for adjustment. Those candidates are filtered, such as based on characteristics of surrounding pixels to remove false-positive candidates (e.g., red pixels closely surrounded by white may be considered likely to be an eye in need of an adjustment, while red pixels that are not close in location to any other natural eye colors may be filtered from further processing). In another example, a user manually identifies areas of the color image where red-eye processing is needed, and pixels in the identified area are identified for correction.

FIG. 2B depicts a pixel mask that includes a value for each of a plurality of pixels of the color image. In the example of FIG. 2B, pixels of the color image that are to undergo red-eye correction are indicated by black pixels, while pixels that are not to undergo correction are indicated by white pixels. The pixel mask may be stored in a computer-readable medium in a variety of ways. In one example, the pixel mask is stored as a stream of values, where a value of 1 indicates that a pixel is identified for correction and a value of 0 indicates that a pixel is not to be corrected. In another example, an array of values having an element corresponding to each pixel of the color image stores values indicating whether corresponding pixels are to be adjusted. In a further example, a data structure stores coordinates of pixels to be adjusted. Having identified pixels to be adjusted, a system for correcting red-eye accesses corresponding pixels in a grayscale representation of the color image and replaces pixels in the color image with the accessed, corresponding pixels from the grayscale representation.

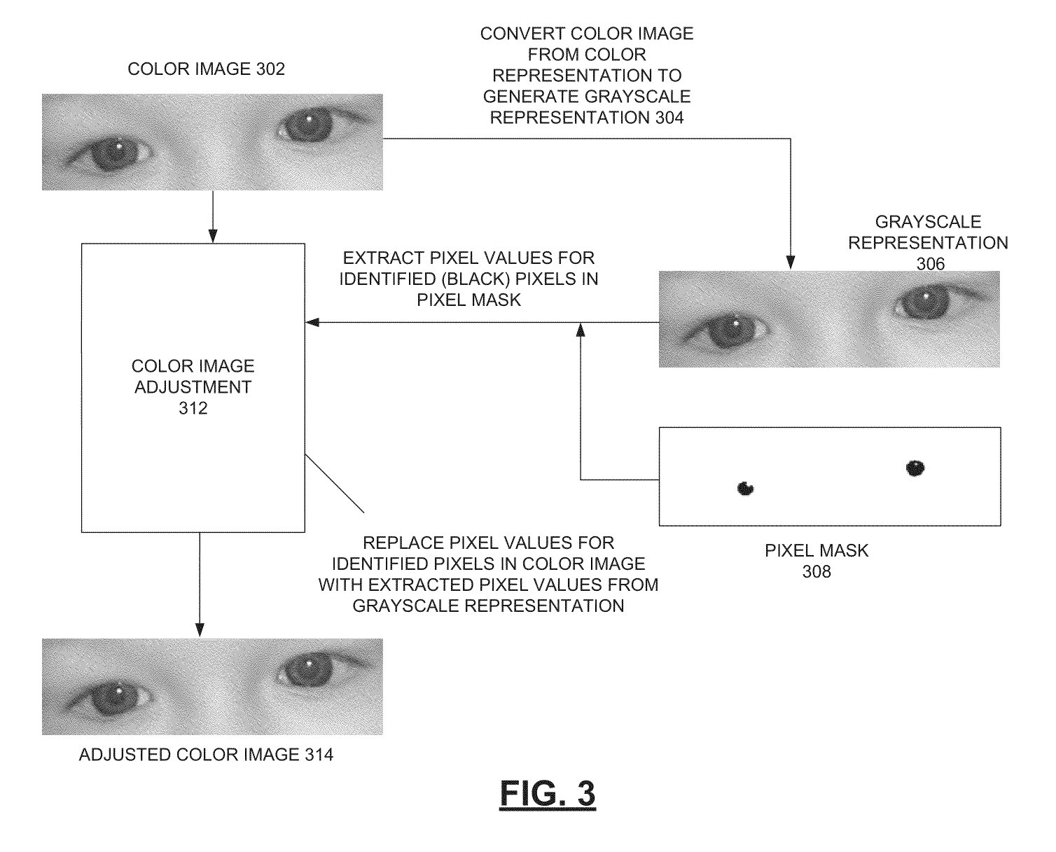

FIG. 3 is a conceptual flow diagram depicting a method of correcting red-eye in a digital image. A color image is provided at 302. At least a portion of the color image is converted from a color representation at 304 to generate a grayscale representation 306. A pixel mask 308 is accessed, where the pixel mask identifies pixels in the color image 302 where red-eye is to be corrected. At 310, pixel values are extracted from the grayscale representation at pixels corresponding to the black pixels of the pixel mask. Color image adjustment is performed at 312, where pixel values corresponding to the identified (black) pixels in the pixel mask are replaced with extracted grayscale pixel values for the corresponding pixels from the grayscale representation 306 to generate an adjusted color image 314 that has the red-eye pixels at the pupils of the image subject replaced by corresponding grayscale representation pixels, thus removing the red-eye.

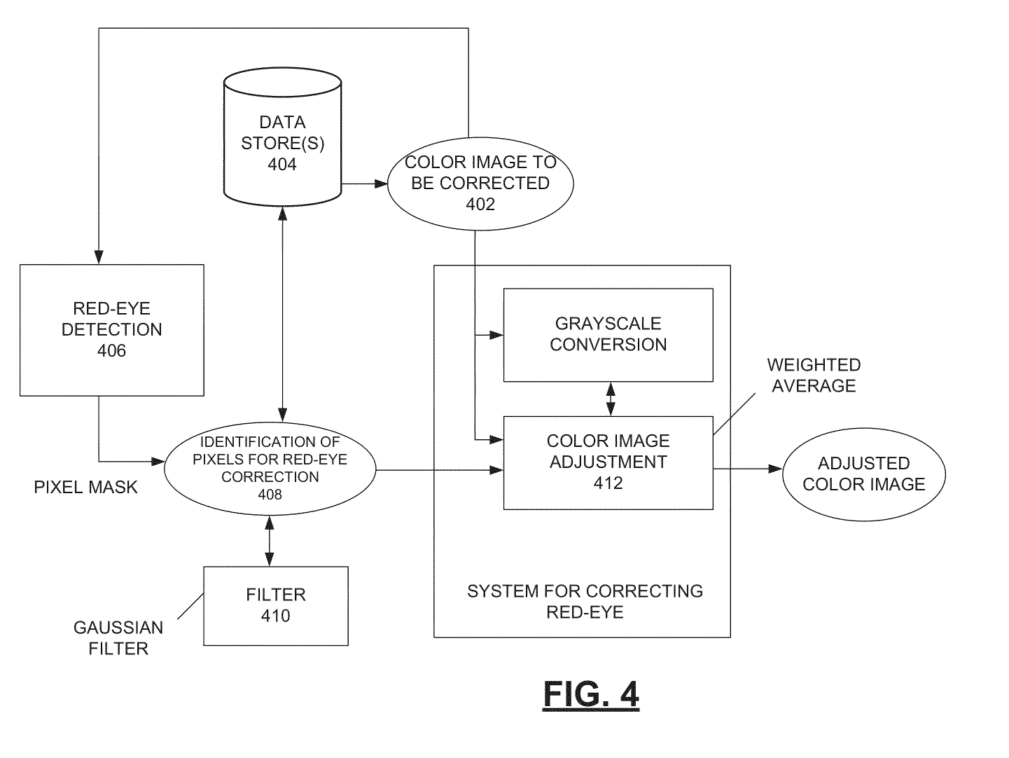

FIG. 4 is a block diagram depicting a system for correcting red-eye in a digital image that includes red-eye detection. A color image to be corrected 402 is accessed from a computer-readable medium, such as a data store 404. The color image to be corrected 402 is provided to a red-eye detection module 406 (e.g., a hardware or software module) for red-eye detection. The red-eye detection module 406 identifies regions or pixels of the color image to be corrected 402 where red-eye correction should be performed. The red-eye detection module 406 saves identifications of pixels 408 in the color image where red-eye correction is to be performed in a computer-readable format, such as a pixel mask. The identification of pixels 408 for red-eye correction is stored in a computer-readable medium, such as data store 404.

In one example, the identification of pixels 408 for correction is adjusted prior to storage and use. For example, a pixel mask representation can be operated on by a Gaussian (e.g., a 3×3 filter) or other filter 410, such as to soften the red-eye correction edges in the pixel mask or otherwise include additional pixels for correction. In one example, the pixel mask is not limited to integer values (e.g., 1 for pixels to be corrected, 0 for pixels to not be corrected), such that locations in the pixel mask can have non-integer values. Such a pixel mask can improve corrections at the edges of red-eye correction areas, such as where red-eye in a photo results in a pink hue near the iris of an image subject. Non-integer pixel mask values can be treated at the color image adjustment module 412 by changing a pixel's value to a weighted average of the grayscale representation and the color representation based on the pixel mask value (e.g., where the pixel mask has a value of 1, the grayscale representation pixel value is used; where the pixel mask has a value of 0, the color representation is used; and where the pixel mask has a value of 0.5, the average of the grayscale representation pixel value and the color representation pixel value is used).

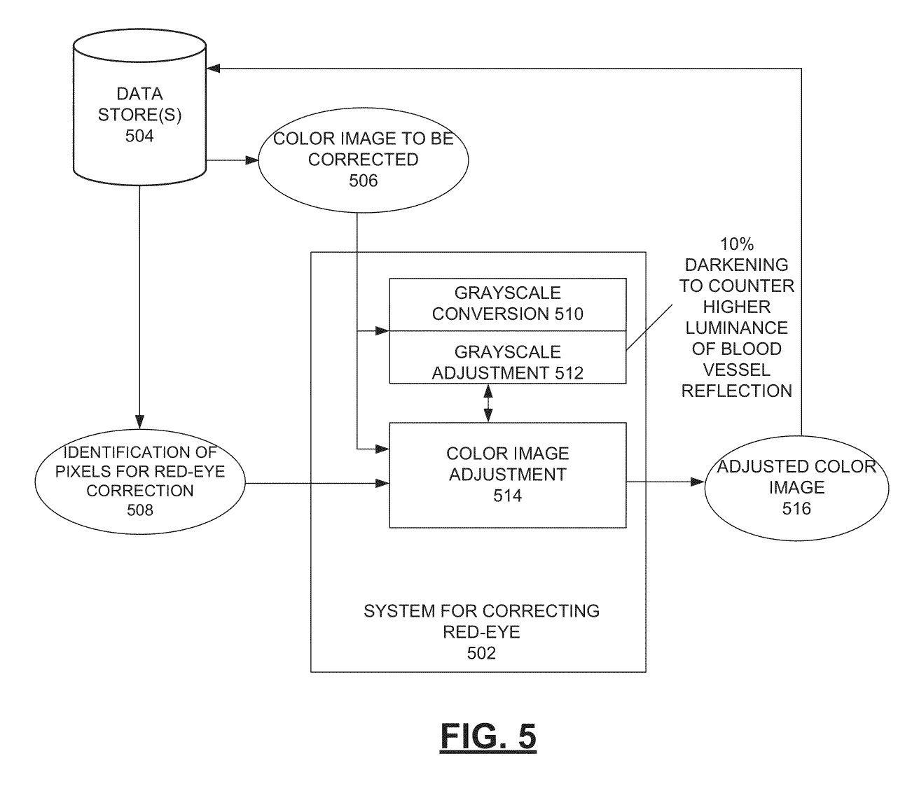

FIG. 5 is a block diagram depicting a system for correcting red-eye in a digital image that includes grayscale representation processing. A system correcting red-eye 502 is responsive to one or more data stores 504 that contains a color image to be corrected 506 as well as an identification 508 of pixels in the color image 506 where red-eye is to be corrected. At 510, the system for correcting red-eye 502 performs a grayscale conversion on at least a portion of the color image to generate a grayscale representation. At 512, the grayscale representation is adjusted, such as by darkening all of the grayscale representation mount, such as 10%. In one example, such an adjustment compensates for an increased luminance of an eye in an image 506 exhibiting red-eye over an eye that does not have red-eye. The adjusted grayscale representation is used at 514 for color image adjustment, where pixel values identified for correction at 508 are replaced/adjusted based on corresponding pixel values in the adjusted grayscale representation from 512 to generate an adjusted color image 516.

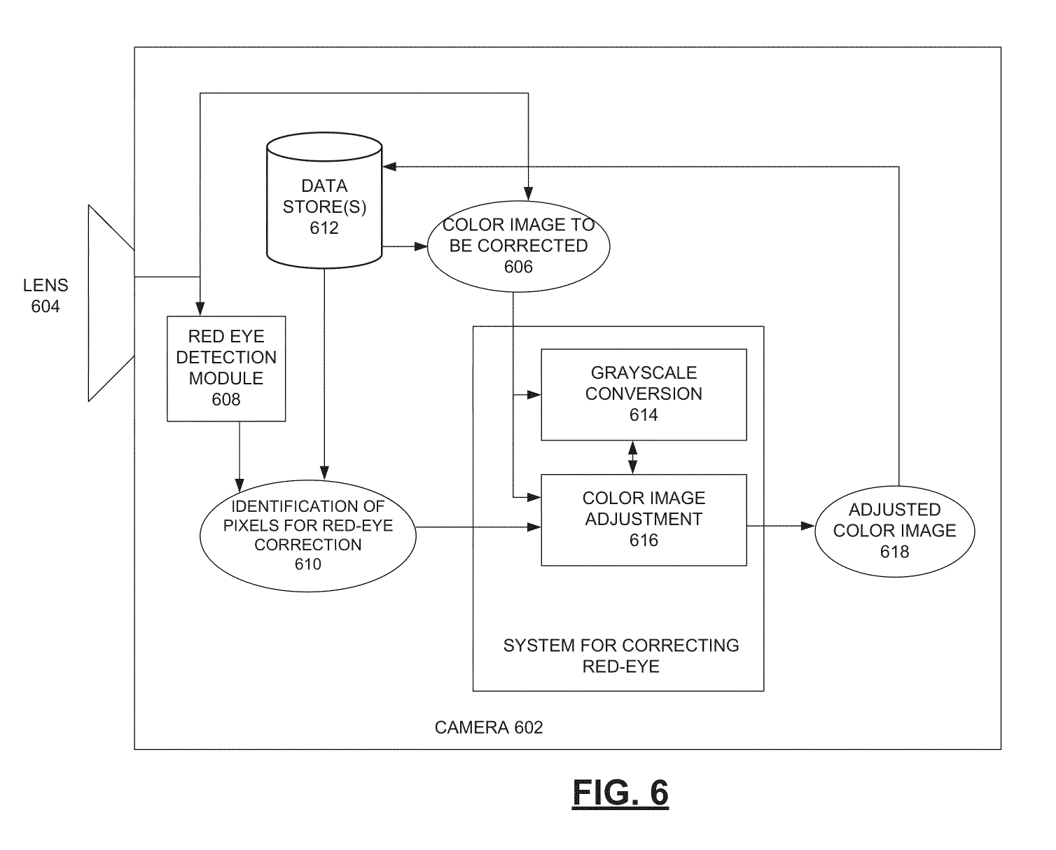

A system for correcting red-eye can be implemented in a variety of contexts. FIG. 6 is a block diagram depicting a system for correcting red-eye in a digital camera. The camera 602 includes a lens 604 configured to capture light to generate a color image 606. A red-eye detection module 608 is configured to identify pixels 610 in the color image where red-eye is to be corrected. One or more computer-readable mediums 612 are configured to store the color image 606 and the identification of pixels 610 in the color image where red-eye is to be corrected. A grayscale conversion module 614 is configured to convert at least a portion of the color image 606 from a color representation to generate a grayscale representation. A color adjustment module 616 is configured to adjust the color image 606 by replacing identified pixels 610 in the color image 606 with corresponding pixels from the grayscale representation to generate an adjusted color image 618, where the adjusted color image 618 is stored in the one or more computer-readable mediums 612.

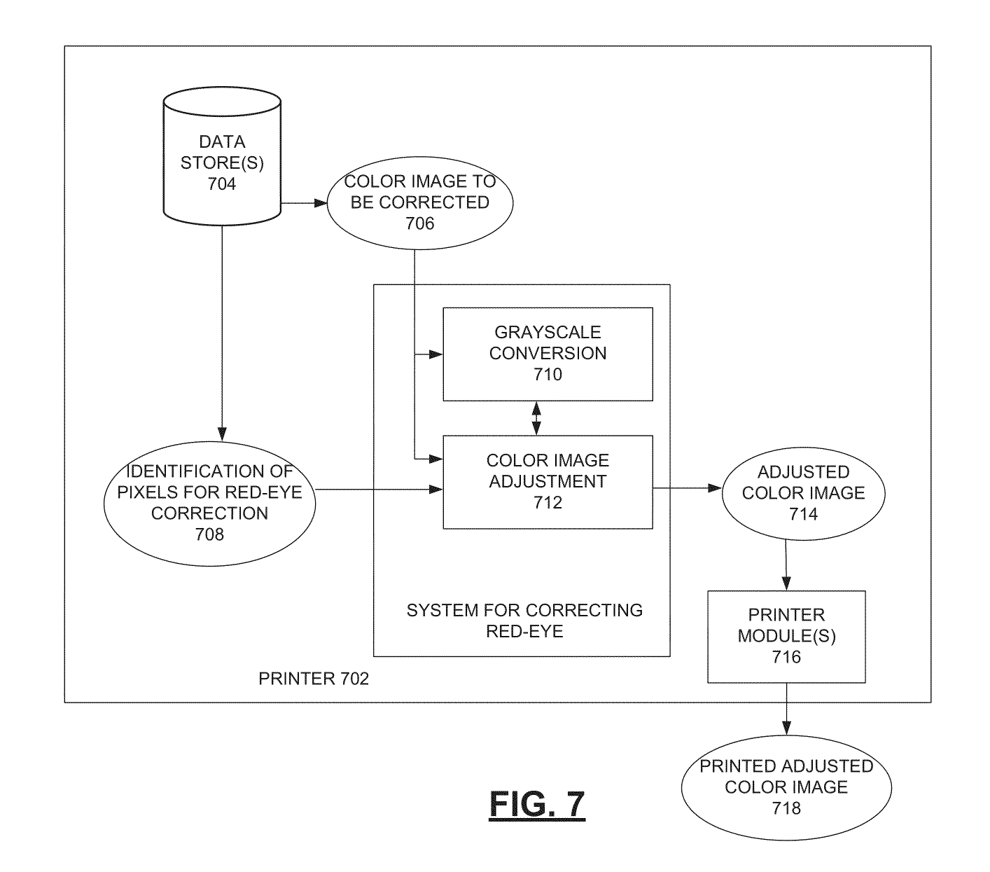

As another example, FIG. 7 is a block diagram depicting a printer configured to correct red-eye in a digital image. The printer 702 includes one or more computer-readable mediums 704 configured to store a color image 706 and an identification of pixels 708 in the color image 706 where red-eye is to be corrected. A grayscale conversion module 710 is configured to convert at least a portion of the color image 706 from a color representation to generate a grayscale representation. A color adjustment module 712 is configured to adjust the color image 706 by replacing identified pixels in the color image 706 with corresponding pixels from the grayscale representation to generate an adjusted color image 714, where the adjusted color image 714 is stored in the one or more computer-readable mediums 704. One or more printer modules 716 that include ink for printing the adjusted color image 714 are configured for printing the adjusted color image 714 to output a printed adjusted color image 718.

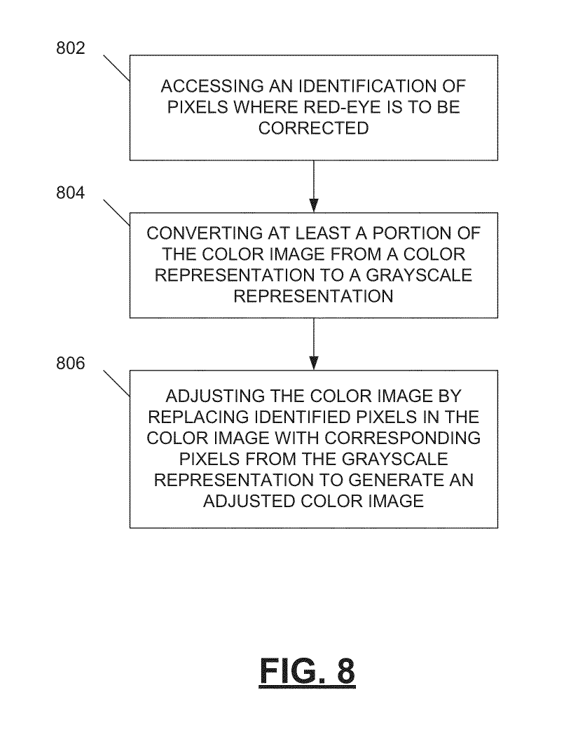

FIG. 8 is a flow diagram depicting a processor-implemented method of correcting red-eye in a digital image. At 802, an identification of pixels in a color image where red-eye is to be corrected is accessed. At 804, at least a portion of the color image is converted from a color representation to generate a grayscale representation. At 806, the color image is adjusted by replacing identified pixels in the color image with corresponding pixels from the grayscale representation to generate an adjusted color image, and the adjusted color image is saved in a computer-readable medium.

This application uses examples to illustrate the invention. The patentable scope of the invention includes other examples.

It is claimed:

1. A processor-implemented method of correcting red-eye in a digital image, comprising:
accessing an identification of pixels in a color image where red-eye is to be corrected;
converting at least a portion of the color image from a color representation to generate a grayscale representation; and
adjusting the color image by replacing identified pixels in the color image with corresponding pixels from the grayscale representation to generate an adjusted color image.

2. The method of claim 1, wherein adjusting the color image comprises:
determining a location of an identified pixel in the color image;
accessing a grayscale pixel value from the grayscale representation at the location; and
changing a pixel value at the location in the color image to the grayscale pixel value.

3. The method of claim 1, wherein the identified pixels are identified by a pixel mask that includes a value for a plurality of pixels of the color image, wherein a first value indicates that a corresponding pixel is an identified pixel to be adjusted and a second value indicates that the corresponding pixel is not to be adjusted.

4. The method of claim 3, further comprising:
adjusting the pixel mask using a filter, wherein more pixels are identified for adjustment after adjustment of the pixel mask.

5. The method of claim 4, wherein the adjustment is performed using a Gaussian filter.

6. The method of claim 4, wherein certain pixels are identified for partial adjustment based on the adjustment of the pixel mask, wherein a particular pixel is partially adjusted based on a pixel value from the grayscale representation, a pixel value from the color image, and a weight value for the particular pixel in the adjusted pixel mask.

7. The method of claim 3, further comprising:
identifying the pixels in the color image to be corrected by performing red-eye detection.

8. The method of claim 1, further comprising:
adjusting pixels of the grayscale representation prior to adjusting the color image.

9. The method of claim 8, wherein adjusting the pixels of the grayscale image includes darkening the pixels of the grayscale representation.

10. The method of claim 9, wherein the pixels of the grayscale representation are darkened by 10%.

11. A system for correcting red-eye in a digital image, comprising:
one or more computer-readable mediums configured to store a color image and an identification of pixels in the color image where red-eye is to be corrected;
a grayscale conversion module configured to convert at least a portion of the color image from a color representation to generate a grayscale representation;
a color adjustment module configured to adjust the color image by replacing identified pixels in the color image with corresponding pixels from the grayscale representation to generate an adjusted color image.

12. The system of claim 11, wherein the color adjustment module is configured to:
determine a location of an identified pixel in the color image;
access a grayscale pixel value from the grayscale representation at the location; and
change a pixel value at the location in the color image to the grayscale pixel value.

13. The system of claim 11, wherein the identified pixels are identified by a pixel mask that includes a value for a plurality of pixels of the color image, wherein a first value indicates that a corresponding pixel is an identified pixel to be adjusted and a second value indicates that the corresponding pixel is not to be adjusted.

14. The system of claim 13, further comprising a filter configured to adjust the pixel mask, wherein more pixels are identified for adjustment after adjustment.

15. The system of claim 12, wherein the filter includes a Gaussian filter.

16. The system of claim 13, further comprising:
a red eye detection module configured to identify the pixels in the color image to be corrected.

17. The system of claim 11, wherein the grayscale conversion module is further configured to adjust pixels of the grayscale representation prior to adjusting the color image.

18. The system of claim 17, wherein adjusting the pixels of the grayscale image includes darkening the pixels of the grayscale representation.

19. A camera configured to correct red-eye in a digital image, comprising:
a lens configured to capture light to generate a color image;
a red-eye detection module configured to identify pixels in the color image where red-eye is to be corrected;
one or more computer-readable mediums configured to store the color image and the identification of pixels in the color image where red-eye is to be corrected;
a grayscale conversion module configured to convert at least a portion of the color image from a color representation to generate a grayscale representation;
a color adjustment module configured to adjust the color image by replacing identified pixels in the color image with corresponding pixels from the grayscale representation to generate an adjusted color image;
wherein the adjusted color image is stored in the one or more computer-readable mediums.

20. A printer configured to correct red-eye in a digital image, comprising:
one or more computer-readable mediums configured to store a color image and an identification of pixels in the color image where red-eye is to be corrected;
a grayscale conversion module configured to convert at least a portion of the color image from a color representation to generate a grayscale representation;
a color adjustment module configured to adjust the color image by replacing identified pixels in the color image with corresponding pixels from the grayscale representation to generate an adjusted color image, wherein the adjusted color image is stored in the one or more computer-readable mediums;
one or more printer modules for printing the adjusted color image; and
ink for printing the adjusted color image using the one or more printer modules.
